(19) United States
(12) Patent Application Publication
(10) Pub. No.: US 2017/0317608 A1
(43) Pub. Date: Nov. 2, 2017

(54) MODE 7 PUSH-PULL STRUCTURE WITH EXTERNAL PULSE WIDTH MODULATOR CONTROL

(71) Applicant: CUMMINS INC., Columbus, IN (US)

(72) Inventors: Fei Gong, Columbus, IN (US); Meenal Vaidya, Greenwood, IN (US); Daniel R. Harshbarger, Columbus, IN (US)

(21) Appl. No.: 15/526,900

(22) PCT Filed: Nov. 17, 2014
(86) PCT No.: PCT/US14/65952

§ 371 Date: May 15, 2017

(51) Int. Cl. H02M 7/538; H02M 7/5387; H02P 27/08; H02M 1/08; H02M 1/00

(52) U.S. Cl. CPC H02M 7/53803; H02P 27/08; H02M 1/08; H02M 7/53873; H02M 2001/0009

(57) ABSTRACT

A circuit, comprising, a first high-side switch and a second high-side switch each receiving a source voltage, a first low-side switch and a second low-side switch, a first application specific integrated circuit (ASIC) connected to the first high-side switch and the first low-side switch, and a second ASIC connected to the second high-side switch and the second low-side switch, wherein the switches are connected to form an H-bridge circuit to generate a drive current, and wherein the first and second ASICs control the switches in a synchronized manner to cause current to flow through a load in one of a first direction and a second direction.

### TECHNICAL FIELD

The present disclosure relates generally to a push-pull driver control module for H-bridge and Brushless DC motor (BLDC) applications. More specifically, a modified push-pull driver control module is provided with dead-time control and interlock fault handling features implemented in a control logic block of application specific integrated circuits (ASICs) to implement an H-bridge pre-driver or a BLDC pre-driver.

### BACKGROUND

In modern technology, a push-pull driver circuit can be used to operate a load in a combustion engine, such as, a fuel injector, an after treatment driver, a turbocharger, an injector driver, an actuator driver, an exhaust throttle, or an intake throttle. Due to disparity in the current and voltage requirements in operating various loads, a push-pull pre-driver circuit is required. The existing approaches do not allow for two or three channels of an H-bridge or BLDC pre-drivers to be implemented on different ASICs or with separate state machines. This limits the flexibility of the pre-driver's usage. For such application, a dedicated H-bridge or BLDC state machine is essential, requiring a minimum number of free channels in one ASIC, which increases device cost.

Thus, there remains a need in the art for apparatuses, methods, and systems of a push-pull pre-driver control module for H-bridge and BLDC motor applications that when implemented to operate a load reduces the overall system cost.

### SUMMARY

In one embodiment, the present disclosure provides a circuit, comprising a first high-side switch and a second high-side switch each receiving a source voltage, a first low-side switch and a second low-side switch, a first application specific integrated circuit (ASIC) connected to the first high-side switch and the first low-side switch, and a second ASIC connected to the second high-side switch and the second low-side switch, wherein the switches are connected to form an H-bridge circuit to generate a drive current and wherein the first and second ASICs control the switches in a synchronized manner to cause current to flow through a load in one of a first direction and a second direction. According to one aspect of this embodiment each of the switches is metal-oxide-semiconductor (MOS). In another aspect of this embodiment, at least one ASIC includes a control logic block configured to provide a programmable high-to-low deadtime, or a programmable low-to-high deadtime. In yet another aspect of this embodiment, the first ASIC has a first synchronization signal output and a first enable signal input, the second ASIC has a second synchronization signal output and a second enable signal input, the first synchronization signal output is connected to the second enable signal input and the second synchronization signal output is connected to the first enable signal input to synchronize operation of the first ASIC and the second ASIC. In another aspect of this embodiment, at least one ASIC includes at least one high-side diagnostic sensor connected in parallel across one of the high-side switches of the H-bridge, each high-side diagnostic sensor being configured to diagnose a fault in the corresponding one of the high-side switches of the H-bridge. In yet another aspect of this embodiment, at least one ASIC includes a low-side diagnostic sensor configured to sense a fault across a low-side switch of the H-bridge. In another aspect of this embodiment further including a sensor connected between ground and a junction of the first low-side switch and the second low-side switch, the sensor being configured to sense a current of the H-bridge.

In another embodiment of the present disclosure, a method comprising generating a plurality of control signals, and providing a first synchronization signal from a first application-specific integrated circuit (ASIC) to a second ASIC and a second synchronization signal from the second ASIC to the first ASIC for synchronizing the first ASIC with the second ASIC, wherein the first ASIC and the second ASIC provide load drive signals to an H-bridge in response to the plurality of control signals and the synchronization signals so that one high-side of the H-bridge and one low-side of the H-bridge operates to drive a load. In another aspect of this embodiment further comprising operating the first ASIC in response to a low signal at a first enable signal input such that a first idle event occurs in which the first ASIC is idle, operating the first ASIC in response to a high signal at the first enable signal input and a low signal at a first pulse width modulator input to cause a first low-side-on event in which the first ASIC generates a low signal at a first high-side gate drive (GH), and a high signal at a first low-side gate drive (GL), operating the first ASIC in response to a high signal at the first enable signal input and a high signal at the first pulse width modulator input to cause a first high-side-on event in which the first ASIC generates a high signal at the GH and a low signal at the GL, transitioning from the low-side-on event in response to a high signal at the first enable signal input and a high signal at the first pulse width modulator input to cause a first low-to-high deadtime event in which the first ASIC is off, transitioning from a high-side-on event in response to a high signal at the first enable signal input and a low signal at the first pulse width modulator input to cause a first high-to-low deadtime event in which the first ASIC is off, and operating the first ASIC in response to a high signal at a second synchronization signal to cause a first fault event in which the first ASIC is turned off. In yet another aspect of this embodiment further comprising operating the second ASIC in response to a low signal at a second enable signal input such that a second idle event occurs in which the second ASIC is idle, operating the second ASIC in response to a high signal at a second enable signal input and a low signal at a second pulse width modulator input to cause a low-side-on event in which the second ASIC generates a low signal at a second GH, and a high signal at a second GL, operating the second ASIC in response to a high signal at the second enable signal input and a high signal at the second pulse width modulator input to cause a high-side-on event in which the second ASIC generates a high signal at the GH and a low signal at the GL, transitioning from the low-side-on event in response to a high signal at the second enable signal input and a high signal at the second pulse width modulator input to cause a second low-to-high deadtime event in which the second ASIC is off, transitioning from the high-side-on event in response to a high signal at the second enable signal input and a low signal at the second pulse width modulator input to cause a second high-to-low deadtime event in which the second ASIC is off, and operating the second ASIC in response to a high signal at a first synchronization signal to cause a second fault event in which the second ASIC is turned off. In another aspect of this embodiment further comprising producing a fault signal in response to a diagnostic signal at one of a high-side switch, a low-side switch, or a current sensor.

In another embodiment of the present discloure, a system comprising a host logic module, and a programmable load driver module coupled to the host logic module and configured to drive a load, wherein the programmable load driver module comprises an H-bridge circuit and a plurality of application-specific integrated circuits (ASICs), wherein the H-bridge circuit is coupled to the plurality of ASICs and comprises two switches on a high-side of the H-bridge and two switches on a low-side of the H-bridge, and wherein each of the plurality of ASICs has an output, the output from the first ASIC being provided as an input signal to the second ASIC and the output from the second ASIC being provided as an input signal to the first ASIC. In another aspect of this embodiment, at least one of the plurality of ASICs further comprises a programmable control logic block configured to provide load drive signals to the H-bridge.

In yet another embodiment of the present disclosure, a circuit comprising a first high-side switch, a second high-side switch and a third high-side switch each receiving a source voltage, a first low-side switch, a second low-side switch, and a third low-side switch, a first application-specific integrated circuit (ASIC) connected to at least one of the first high-side switch, the second high-side switch and the third high-side switch, and at least one of the first low-side switch, the second low-side switch and the third low-side switch, and a second ASIC connected to at least one of the first high-side switch, the second high-side switch and the third high-side switch, and at least one of the first low-side switch, the second low-side switch, and the third low-side switch, wherein the ASICs control synchronized operation of the switches which are connected to form a three-phase circuit to generate a drive current. According to one aspect of this embodiment further comprising, a third ASIC, wherein the first ASIC is connected to the first high-side switch and the first low-side switch, the second ASIC is connected to the second high-side switch and the second low-side switch, and the third ASIC is connected to the third high-side switch and the third low-side switch. In another aspect of this embodiment, each of the switches is metal-oxide-semiconductor (MOS). In yet another aspect of this embodiment, at least one ASIC includes a control logic block configured to provide a programmable high-to-low deadtime, or a programmable low-to-high deadtime. In another aspect of this embodiment, the first ASIC has a first synchronization signal output and a first enable signal input, the second ASIC has a second synchronization signal output and a second enable signal input, and the third ASIC has a third synchronization signal output and a third enable signal input, wherein the first synchronization signal output is connected to the second enable signal input and to the third enable signal input, the second synchronization signal output is connected to the first enable signal input and the third enable signal input, and the third synchronization signal output is connected to the first enable signal input and the second enable signal input to synchronize the first ASIC, the second ASIC, and the third ASIC. In yet another aspect of this embodiment, at least one ASIC includes at least one high-side diagnostic sensor connected in parallel across one of the high-side switches of the three-phase circuit, wherein each high-side diagnostic sensor is configured to diagnose a fault in the corresponding one of the high-side switches of the three-phase circuit. In another aspect of this embodiment, at least one ASIC includes a low-side diagnostic sensor configured to sense a fault across a low-side switch of the three-phase circuit. In yet another aspect of this embodiment, each one of the high-side switches is connected to one of the corresponding low-side switches to form a bridge, each bridge including a sensor configured to sense a current in the three-phase circuit

In yet another embodiment of present disclosure, a system comprising a host logic module and a programmable three-phase load driver module coupled to the host logic module and configured to drive a load, wherein the programmable three-phase load driver module comprises a three-phase power circuit and a plurality of application-specific integrated circuits (ASICs), wherein the three-phase power circuit is coupled to the plurality of ASICs and comprises three MOS switches on a high-side of the three-phase power circuit and three MOS switches on a low-side of the three-phase power circuit, and wherein each of the plurality of ASICs has an output, the output from the first ASIC being provided as an input signal to the second ASIC and the third ASIC, the output from the second ASIC being provided as an input signal to the first ASIC and the third ASIC, and the output from the third ASIC being provided as an input signal to the first ASIC and the second ASIC. In one aspect of this embodiment, at least one of the plurality of ASICs each includes a control logic block configured to provide load drive signals to the three-phase power circuit.

In another embodiment of the present disclosure, a method comprising, generating a plurality of control signals, and providing a first synchronization signal from a first application-specific integrated circuit (ASIC) to a second ASIC and a third ASIC, a second synchronization signal from the second ASIC to the first ASIC and the third ASIC, and a third synchronization signal from the third ASIC to the first ASIC and the second ASIC for synchronizing the first ASIC, the second ASIC, and the third ASIC, wherein the first ASIC, the second ASIC, and the third ASIC provide load drive signals to a three-phase circuit in response to the plurality of control signals and the synchronization signals so that one high-side of the three-phase circuit and one low-side of the three-phase circuit operates to drive a load. According to one aspect of this embodiment further comprising, operating the first ASIC in response to a low signal at a first enable signal input such that a first idle event occurs in which the first ASIC is idle, operating the first ASIC in response to a high signal at the first enable signal input and a low signal at a first pulse width modulator input to cause a first low-side-on event in which the first ASIC generates a low signal at a first high-side gate drive (GH), and a high signal at a first low-side gate drive (GL), operating the first ASIC in response to a high signal at the first enable signal input and a high signal at the first pulse width modulator input to cause a first high-side-on event in which the first ASIC generates a high signal at the GH and a low signal at the second GL, transitioning from the low-side-on event in response to a high signal at the first enable signal input and a high signal at the first pulse width modulator input to cause a first low-to-high deadtime event in which the first ASIC is off, transitioning from a high-side-on event in response to a low signal at the first enable signal input and a high signal at the first pulse width modulator input to cause a first high-to-low deadtime event in which the first ASIC is off, operating the first ASIC in response to a high signal at the second synchronization signal to cause a first fault event in which the first ASIC is turned off, and operating the first ASIC in response to a high signal at the third synchronization signal to cause a first fault event in which the first ASIC is turned off. According to yet another aspect of this embodiment further comprising, operating the second ASIC in response to a low signal at a second enable signal input such that a second idle event occurs in which the second ASIC is idle, operating the second ASIC in response to a high signal at a second enable signal input and a low signal at a second pulse width modulator input to cause a low-side-on event in which the second ASIC generates a low signal at a second GH, and a high signal at a second GL, operating the second ASIC in response to a high signal at the second enable signal input and a high signal at the second pulse width modulator input to cause a high-side-on event in which the second ASIC generates a high signal at the GH and a low signal at the second GL, transitioning from the low-side-on event in response to a high signal at the second enable signal input and a high signal at the second pulse width modulator input to cause a second low-to-high deadtime event in which the second ASIC is off, transitioning from the high-side-on event in response to a low signal at the second enable signal input and a high signal at the second pulse width modulator input to cause a second high-to-low deadtime event in which the second ASIC is off, operating the second ASIC in response to a high signal at the first synchronization signal to cause a second fault event in which the second ASIC is turned off, and operating the second ASIC in response to a high signal at the third synchronization signal to cause the second fault event in which the second ASIC is turned off. According to yet another aspect of this embodiment, further comprising operating the third ASIC in response to a low signal at a third enable signal input such that a third idle event occurs in which the third ASIC is idle, operating the third ASIC in response to a high signal at a third enable signal input and a low signal at a third pulse width modulator input to cause a low-side-on event in which the third ASIC generates a low signal at a third GH, and a high signal at a third GL, operating the third ASIC in response to a high signal at the third enable signal input and a high signal at the third pulse width modulator input to cause a high-side-on event in which the third ASIC generates a high signal at the GH and a low signal at the third GL, transitioning from the low-side-on event in response to a high signal at the third enable signal input and a high signal at the third pulse width modulator input to cause a third low-to-high deadtime event in which the third ASIC is off, transitioning from the high-side-on event in response to a low signal at the third enable signal input and a high signal at the third pulse width modulator input to cause a third high-to-low deadtime event in which the third ASIC is off, operating the third ASIC in response to a high signal at the first synchronization signal to cause a third fault event in which the third ASIC is turned off, and operating the third ASIC in response to a high signal at the second synchronization signal to cause the third fault event in which the third ASIC is turned off. According to another aspect of this embodiment further comprising producing a fault signal in response to a diagnostic signal at one of a high-side switch, a low-side switch, or a current sensor.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein;

FIG. 1 is a block diagram of an exemplary system in which a programmable load driver module including an H-bridge circuit can be implemented according to present disclosure;

FIG. 2 is a schematic diagram of an exemplary programmable load driver module of the system of FIG. 1;

FIG. 3 is a state machine diagram of the programmable load driver module of FIG. 2 and an exemplary state machine diagram of the programmable 3-phase load driver module of FIG. 5;

FIG. 4 is a block diagram of an exemplary system in which a programmable three-phase load driver module is implemented according to present disclosure; and

FIG. 5 is a schematic diagram of an exemplary programmable 3-phase load driver module of the system of FIG. 4.

Although the drawings represent embodiments of the various features and components according to the present disclosure, the drawings are not necessarily to scale and certain features may be exaggerated in order to better illustrate and explain the present disclosure. The exemplification set out herein illustrates embodiments of the disclosure, and such exemplifications are not to be construed as limiting the scope of the disclosure in any manner.

### DETAILED DESCRIPTION OF EMBODIMENTS

For the purpose of promoting an understanding of the principles of the disclosure, reference will now be made to the embodiments illustrated in the drawings, which are described below. It will nevertheless be understood that no limitation of the scope of the disclosure is thereby intended. The disclosure includes any alterations and further modifications in the illustrated device and described methods and further applications of the principles of the disclosure, which would normally occur to one skilled in the art to which the disclosure relates. Moreover, the embodiments were selected for description to enable one of ordinary skill in the art to practice the disclosure.

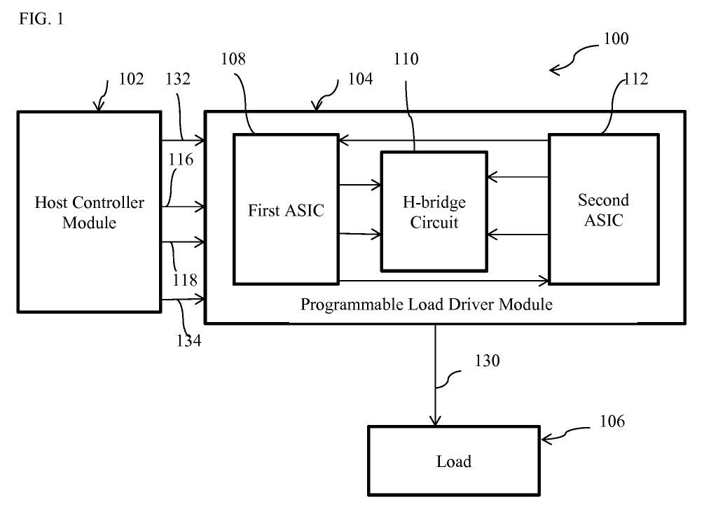

Referring now to FIG. 1, a system 100 according to one embodiment of the present disclosure is depicted as including a host controller module 102, a programmable load driver module 104, and a load 106. Host controller module 102 generally includes a microcontroller unit (not shown) configured to send control signals to the programmable load driver module 104. Microcontroller unit generally may include a processor, a memory, and peripherals. The microcontroller unit may be programmable or non-programmable. The host controller module 102 provides a plurality of pulse width modulation signals (“PMW”) 116, and enable signals 118 to programmable load driver module 104 to drive a certain target load 106. Host controller module 102 may drive a plurality of programmable load drivers 104 or other drivers (not shown) together in parallel or series. Host controller module 102 may be a general computer device having a memory, a microprocessor, and a control processing unit.

Generally, load 106 may be any load which operates on electricity. More specifically, load 106 is a load device within a combustion engine, for example, a fuel injector, an after treatment driver, a turbocharger, an injector driver, an actuator driver, an exhaust throttle, DC motor, or an intake throttle. Load 106 is coupled to programmable load driver module 104 which provides driving signals 130 to the load 106. Programmable load driver may drive one load 106 or multiple loads (not shown) together in parallel or series.

Still referring to FIG. 1, the programmable load driver module 104 generally includes a first ASIC 108, a second ASIC 112, and an H-bridge circuit 110. Programmable load driver module 104 may be installed inside an engine control module (“ECM”) (not shown) of a combustion engine (not shown). The programmable load driver module 104 is configured to process the input enable 118 and PMW 116 signals according to programmable logic and produce control signals 130 to drive load 106. First ASIC 108 and second ASIC 112 may have similar configurations or different configurations. Only one channel of each of first ASIC 108 and second ASIC 112 is configured to operate in the manner described herein. Therefore, other channels of each of first ASIC 108 and second ASIC 112 may be used to control other circuits or devices or may remain unused. First ASIC 108 and second ASIC 112 may be configurable output driver ASICs (“COD ASICs”) having a total of four channels each.

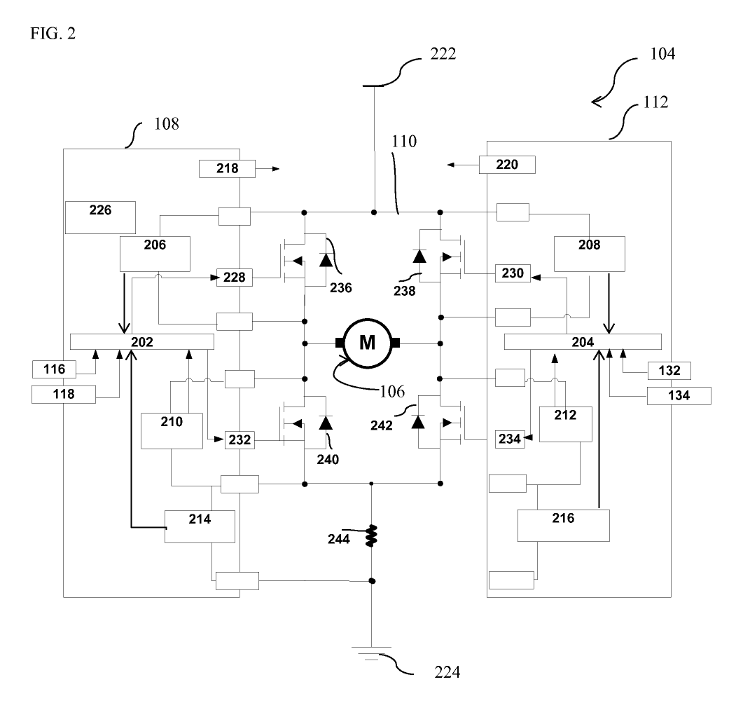

Referring now to FIG. 2, the programmable load driver module 104 is depicted as including first ASIC 108, second ASIC 112, an H-bridge circuit 110, a voltage source 222, and a ground connection 224. H-bridge circuit 110 further includes four switches: a first high-side switch 236, a second high-side switch 238, a first low-side switch 240, and a second low-side switch 242. First high-side switch 236 and second high-side switch 238 are connected at the high-side of H-bridge circuit 110, whereas first low-side switch 240 and second low-side switch 242 are connected at a low-side of H-bridge circuit 110. First high-side switch 236 and second high-side switch 238 are further connected to voltage source 222, and first low-side switch 240 and second low-side switch 242 are both connected to ground connection 224. Furthermore, first ASIC 108 is connected to first high-side switch 236 and first low-side switch 240. Similarly, second ASIC 112 is connected to second high-side switch 238 and second low-side switch 242. Load 106 is connected at a junction between the two high-side switches and the two low-side switches of H-bridge circuit 110. The two high-side switches and low-side switches may be metal-oxide-semiconductors (“MOS”). Additionally, the two high-side switches and two low-side switches may be any type of power transistors, for example, metal oxide semiconductor field effect transistors (“MOSFET”), graphene base transistors (“GBT”), or bipolar transistors. The programmable load driver module 104 may also include a resistor 244 connected between ground connection 224 and a middle junction of the two low-side switches.

Still referring to FIG. 2, first ASIC 108 includes a first control logic block 202, a first high-side diagnostic sensor 206, a first low-side diagnostic sensor 210, a first synchronization signal 218, and a first sensor 214. The first control logic block 202 receives a plurality of input signals including: first PWM 116, a first low-side diagnostic sensor signal, a first high-side diagnostic sensor signal, an output signal from first sensor 214, and first enable signal 118. First control logic block 202 also sends a plurality of output signals: first high-side gate 228 (“GH1”), first low-side gate 232 (“GL1”), and a first synchronization signal 218. First control logic block 202 may be a programmable or non-programmable logic block. GH1 228 is connected at a gate of first high-side switch 236, and GL1 232 is connected at a gate of the first low-side switch 240. First high-side diagnostic sensor 206 is connected across first high-side switch 236, and first low-side diagnostic sensor 210 is connected across first low-side switch 240. First high-side diagnostic sensor 206 and first low-side diagnostic sensor 210 may be any type of sensor capable of sensing voltage, current, voltage difference, or of diagnosing faults across the corresponding switch.

Second ASIC 112 includes a second control logic block 204, a second high-side diagnostic sensor 208, a second low-side diagnostic sensor 212, a second synchronization signal 220, and a second current sensor 216. Second control logic block 204 receives a plurality of input signals including: second PWM 132, a second low-side diagnostic sensor signal, a second high-side diagnostic sensor signal, an output signal from second sensor 216, and second enable signal 134. Second control logic block 204 also produces a plurality of output signals including second high-side gate (“GH2”) 230, second low-side gate (“GL2”) 234, and second synchronization signal 220. Second control logic block 204 may be a programmable or non-programmable logic block. GH2 230 is connected at a gate of second high-side switch 238 and GL2 234 is connected at a gate of second low-side switch 242. Second high-side diagnostic sensor 208 is connected across second high-side switch 238 and second low-side diagnostic sensor 212 is connected across second low-side switch 242. Second high-side diagnostic sensor 208 and second low-side diagnostic sensor 212 may be any type of sensor capable of sensing voltage, current, voltage difference, or of diagnosing faults across the corresponding switch. One having the ordinary skill in the art will realize that the first high-side diagnostic sensor 206, first low-side diagnostic sensor 210, second high-side diagnostic sensor 208, and second low-side diagnostic sensor 212 can be connected to the corresponding switches in various ways for sensing voltage, current, voltage difference, or for diagnosing faults. First synchronization signal 218 is coupled to second enable signal 134 and second synchronization signal 220 is coupled to first enable signal 118 to synchronize first ASIC 108 with second ASIC 112.

In one embodiment of the present disclosure, sensors 214 and 216 may be placed outside first ASIC 108 and second ASIC 112, respectively. In yet another embodiment of the present disclosure, one or both sensors 214 and 216 may be connected to a current amplifier (not shown) configured to amplify current. Sensors 214 and 216 may be configured to regulate current. In another embodiment of the present disclosure, first ASIC 108 or second ASIC 112 may include a charge pump 226, boostrap (not shown), or any other device configured to provide a positive voltage to the corresponding high-side switch.

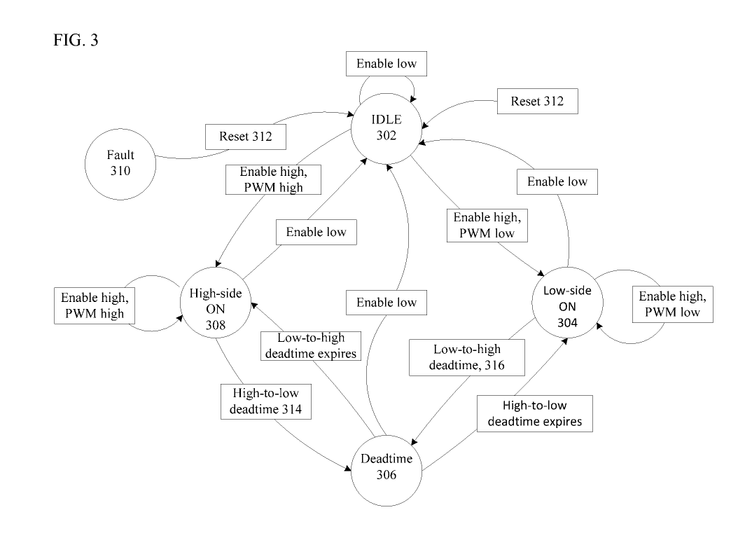

Referring now to FIG. 3, a finite state machine diagram is depicted. Generally, each of first ASIC 108 and second ASIC 112 includes a minimum of three states: an idle state, a high-side on state, and a low-side on state. Furthermore, each of the first ASIC 108 and second ASIC 112 may also include two supporting states: a deadtime state, and fault state. The two supporting states may be combined into any one of the three necessary states (not shown), or may exist separately (as shown) in a finite state machine diagram. The finite state machine diagram of FIG. 3 is described herein with reference to first ASIC 108. The first idle state 302 occurs when first enable signal 118 is low, or first reset 312 is on. During first idle state 302, output signals GH1 228 and GL1 232 are low. The first low-side on state 304 occurs when first enable signal 118 is high and first PWM 116 is low. In first low-side on state 304, GH1 228 is low and GL1 232 is high, therefore, first high-side switch 236 is off and first low-side switch 240 is on. The first high-side on state 308 occurs when both first enable signal 118 and first PWM 116 are high. During high-side on state 308, GH1 228 is high and GL1 232 is low (i.e., high-side switch 236 is on and low-side switch 232 is off). The deadtime state 306 is a transition state for specific dead time duration while transitioning from high-side on state 308 to low-side on state 304 or from low-side on state 304 to high-side on state 308. Deadtime state 306 may have a programmable dead time duration or non-programmable dead time duration. During deadtime state 306, signals GH1 228 and GL1 232 remain low and both of first high-side and first low-side switches are off. The dead time duration from high-side on state 308 to low-side on state 304 is referred to as a high-to-low deadtime 314 and the time duration from low-side on state 304 to high-side on state 308 is referred to as a low-to-high deadtime 316. High-to-low deadtime 314 and low-to-high deadtime 316 may have similar dead time durations or different dead time durations. The first fault state 310 occurs when any one of the fault signals is high. It should be understood that while five states are defined hereinabove as depending on specific input signals, in certain embodiments, these states may be defined differently without affecting the implementation of the present disclosure. For example, in certain embodiments, first low-side on state 304 may occur when first enable signal 118 is high and first PWM 116 is high, and high-side on state 308 may occur with a high first enable signal 118 and low first PWM 116. Furthermore, in certain embodiments, the first PWM can be a derivative of a PWM signal.

Similarly, the second ASIC 112 also includes a finite state machine as depicted in FIG. 3. The second state machine may include similar features as discussed above with reference to FIG. 3. Operationally, for current to flow from H-bridge circuit 110 to load 106 (in either direction) only one of the high-side switches and one of the low-side switches will remain on. Initially, all of the switches are off and no current flows through H-bridge circuit 110. During this state, all outputs GH1 228, GL1 232, GH2 230, and GL2 242 are low. By adjusting the high-side and low-side of H-bridge circuit 110, the current flows through load 106 in either of the two directions: left-to-right or right-to-left. For current to flow from left-to-right through load 106, first ASIC 108 is in high-side on state 308, where high-side switch 236 is on, and second ASIC 112 is in low-side on state 304, where low-side switch 242 is on. The current will flow from voltage source 222, through first high-side switch 236, through load 106 (left-to-right), through second low-side switch 242 then to ground connection 224. Next, for current to flow from right-to-left though load 106, first ASIC 108 is in low-side on state 304, where first low-side switch 240 is on, and second ASIC 112 is in high-side on state 308, where second high-side switch 238 is on. In this example, the current will flow from voltage source 222, through second high-side switch 238, through load 106 (right-to-left), through first low-side switch 240 then to ground connection 224. Furthermore, if either of the two sensors 214 and 216 senses current over a predefined limit, then the corresponding output signal, GH1, GH2, GL1, or GL2, is pulse width modulated with the corresponding PWM signal.

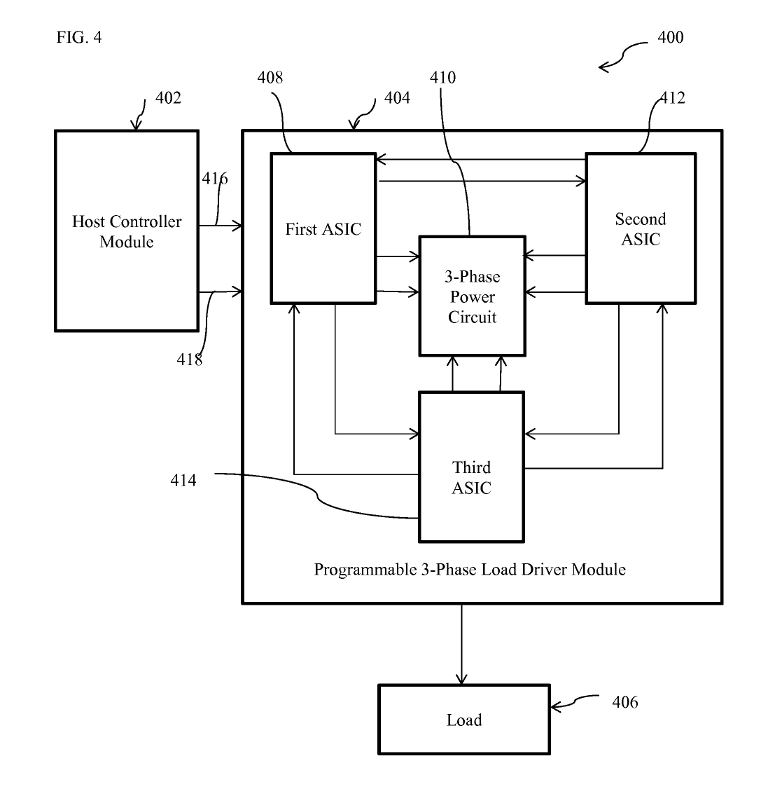

Referring now to FIG. 4, a system 400 according to one embodiment of the present disclosure is depicted as including a host controller module 402, a programmable 3-phase load driver module 404, and a load 406. Host controller module 402 generally includes a microcontroller unit (not shown) configured to send control signals 416 to the programmable 3-phase load driver module 404. The microcontroller unit may include similar characteristics as discussed above with reference to FIG. 1. The host controller module 402 provides a plurality of PMW signals and a plurality of enable signals (discussed later) to programmable 3-phase load driver module 404 to drive a certain target load 406. Host controller module 402 may drive other programmable or non-programmable drivers in parallel or in series with the programmable 3-phase load driver module 404.

Generally, load 406 may be a load which operates on electricity. More specifically, load 406 is a 3-phase winding circuitry load. Load 406 may be a 3-phase brushless DC motor or a brushed motor (not shown). DC motor may a wye-winding or a delta winding style DC motor. Load 406 may include similar characteristics as discussed above with reference to FIG. 1. Load 406 is coupled to the 3-phase programmable load driver module 404 which provides driving signals to load 406.

Still referring to FIG. 4, programmable 3-phase load driver module 404 generally includes a first ASIC 408, a second ASIC 412, a third ASIC 414, and a 3-phase power circuit 410. Programmable 3-phase load driver module 404 may be installed inside an ECM (not shown) of a combustion engine (not shown). First ASIC 408, second ASIC 412, and third ASIC 414 may have similar configurations or different configurations. One channel of each of first ASIC 408, second ASIC 412, and third ASIC 414 is configured to operate in the manner described herein. Therefore, other channels of each of first ASIC 408, second ASIC 412, and third ASIC 414 may be used to control or drive other circuits or may remain unused. First ASIC 408, second ASIC 412, and third ASIC 414 may be configurable output driver ASICs (“COD ASIC”) having a total of four channels each.

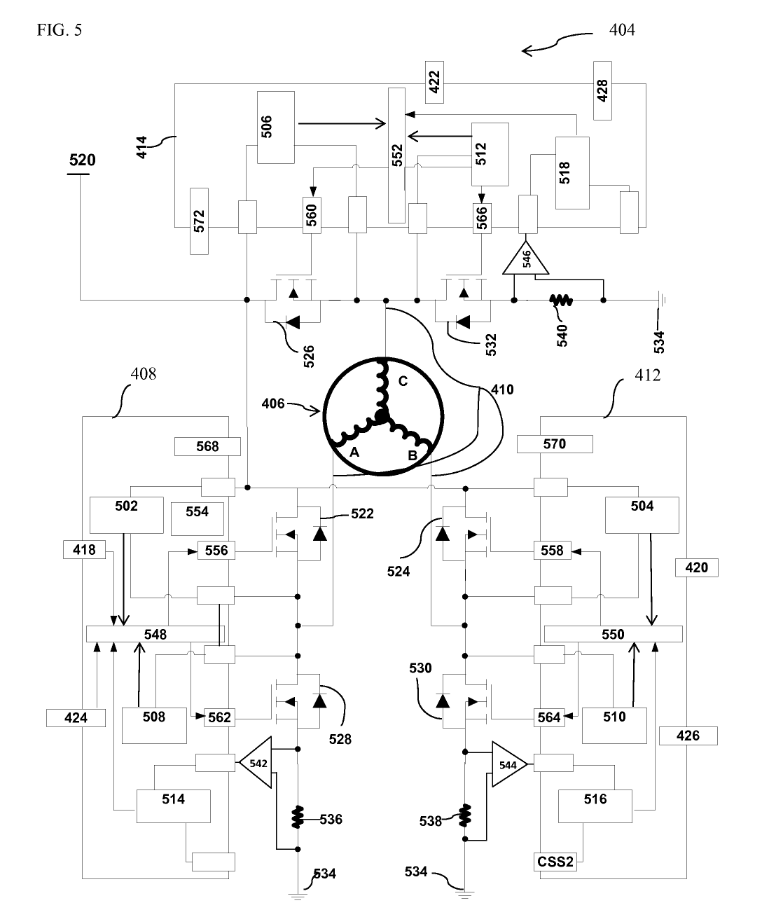

Referring now to FIG. 5, the 3-phase programmable load driver module 404 is depicted as including first ASIC 408, a second ASIC 412, third ASIC 414, a 3-phase power circuit 410, a first high-side diagnostic sensor 502, a second high-side diagnostic sensor 504, a third high-side diagnostic sensor 506, a first low-side diagnostic sensor 508, a second low-side diagnostic sensor 510, a third low-side diagnostic sensor 512, a ground connection 534, and a voltage source 520. First high-side switch 522, a second high-side switch 524, a third high-side switch 526, and a first low-side switch 528, a second low-side switch 530, a third low-side switch 532 form a 3-phase power circuit 410 connected across a voltage source 520. First high-side switch 522 and first low-side switch 528 form one bridge where first high-side switch 522 is connected to high voltage source 520 and first low-side switch 528 is connected to ground connection 534. Similarly, second high-side switch 524 and second low-side switch 530 form one bridge where second high-side switch 524 is connected to high voltage source 520 and second low-side switch 530 is connected to ground connection 534. Third high-side switch 526 and third low-side switch 532 form one bridge where third high-side switch 526 is connected to high voltage source 520 and third low-side switch 532 is connected to ground connection 534.

First ASIC 408 is connected to first high-side switch 522 and first low-side switch 528. Second ASIC 412 is connected to second high-side switch 522 and second low-side switch 530. Similarly, third ASIC 414 is connected to third high-side switch 526 and third low-side switch 532. Three high-side switches and three low-side switches may have similar characteristic as discussed above in reference with FIG. 2. Three-phase programmable load driver module 404 may include a first resistor 536, a second resistor 538, and a third resistor 540. One end of each of resistors 536, 538, 540 is connected to a corresponding low-side switch and the other end is connected to ground connection 534. Additionally, the inputs to first amplifier 542, second amplifier 544, and third amplifier 546 are connected across the corresponding first resistor 536, second resistor 538, and third resistor 540, respectively (as shown). Each amplifier 542, 544, and 546 may be placed inside of first ASIC 408, second ASIC 412, and third ASIC 414, respectively (not shown) or may be placed outside each of the corresponding ASICs (as shown). First sensor 514, second sensor 516, and third sensor 518 are configured to sense current in 3-phase power circuit 410. Each sensor 514, 516 and 518 may be inside first ASIC 408, second ASIC 412, and third ASIC 414, respectively (as shown) or may be placed outside each of the corresponding ASICs (not shown). First ASIC 408, second ASIC 412, and third ASIC 414 may also include a charge pump (not shown), boostrap (not shown), or any other device configured to provide a positive voltage to the high-side switch of the corresponding ASIC.

Still referring to FIG. 5, first ASIC 408 includes a first control logic block 548, second ASIC 412 includes a second control logic block 550, and third ASIC 414 includes a third control logic block 552. Generally, each of the plurality of control logic blocks are configured to receive control signals from host controller module 402 (not shown), and send control and driving signals to each of the corresponding switches of 3-phase circuit 410 to drive load 406. Each of control logic blocks may be programmable or non-programmable.

First control logic block 548 send a plurality of output signals: an output signal to first high-side gate (GH1) 556, an output signal to first low-side gate output (GL1) 562, and a first synchronization signal 568. Additionally, first control logic block 548 receives a plurality of input signals including: a first high-side diagnostic sensor signal, a first low-side diagnostic sensor signal, a first enable signal 424, an output signal from first sensor 514, and an output signal from first PWM 418. First high-side diagnostic sensor 502 is connected across first high-side switch 522 and is configured to sense voltage, current, a voltage difference, or diagnostic faults across the corresponding switch. Similarly, first low-side diagnostic sensor 508 is connected across first low-side switch 528 and is configured to sense voltage, current, a voltage difference, or diagnostic faults across the corresponding switch.

Similar to first control logic block 548, second control logic block 550 produces a plurality of signals: an output signal to second high-side gate (GH2) 558, an output signal to second low-side gate (GL2) 564, and a second synchronization signal 570. Furthermore, second control logic block 550 receives a plurality of input signals including: a second high-side diagnostic sensor 504 signal, a second low-side diagnostic sensor 510 signal, an output signal from second sensor 516, an output signal from second PWM 420, and a second enable signal 426. Each of plurality of deadtimes may be programmable or non-programmable. Second high-side sensor 504 is connected across second high-side switch 524, and is configured to sense voltage, current, voltage difference, or diagnostic faults across the corresponding switch. Similarly, second low-side sensor 510 is connected across second low-side switch 530 and is configured to sense voltage, current, voltage difference, or diagnostic faults across the corresponding switch.

Similar to first control logic block 548 and second control logic block 550, third control logic block 552 also sends a plurality of signals: an output signal to third high-side gate (GH3) 560, an output signal to third low-side gate (GL3) 566, and a third synchronization signal 572. Furthermore, third control logic block 552 receives a plurality of input signals including: a third high-side diagnostic sensor 506 signal, a third low-side diagnostic sensor 512 signal, an output signal from third sensor 518, an output signal from third PWM 422, and an output signal from third enable signal 428. Third high-side sensor 506 is connected across third high-side switch 526, and is configured to sense voltage, current, voltage difference, or diagnostic faults across the corresponding switch. Similarly, third low-side sensor 512 is connected across third low-side switch 532 and is configured to sense voltage, current, voltage difference, or diagnostic faults across the corresponding switch. One having the ordinary skill in the art will realize that the first high-side diagnostic sensor 502, first low-side diagnostic sensor 508, second high-side diagnostic sensor 504, second low-side diagnostic sensor 510, third high-side diagnostic sensor 506, and the third low-side diagnostic sensor 512 can be connected to the corresponding switches in various ways for sensing voltage, current, voltage difference, or for diagnosing faults.

Still referring to FIG. 5, first synchronization signal 568 is connected to the second enable signal 426, and third enable signal 428. Similarly, second synchronization signal 570 connected to first enable signal 424 and third enable signal 428, and third synchronization signal 572 is connected to first enable signal 424 and second enable signal 426. First synchronization signal 568 synchronizes the first ASIC 408 with second ASIC 412 and third ASIC 414. Similarly, second synchronization signal 570 synchronizes second ASIC 412 with first ASIC 408 and third ASIC 414, and lastly, third synchronization signal 572 synchronizes third ASIC 414 with first ASIC 408 and second ASIC 412. It should be understood that while the 3-phase programmable load driver module 404 is defined hereinabove as including three ASICs, in certain embodiments, the 3-phase programmable load driver module 404 may only include two ASICs; one of the AISCs may be connected to two high-side switches and two low-side switches, and the other ASIC may be connected to remaining one of the high-side switch and the low-side switch (not shown).

First ASIC 408, second ASIC 412, and third ASIC 414 each have a finite state machine with similar features as discussed above with reference to FIG. 3. Operationally, two of the three electrical load windings are energized at one point of time. To energize each of the windings, external current is supplied to the load 406 through 3-phase circuit 410. One end of winding A is connected at a junction of first high-side switch 522 and first low-side switch 528, whereas one end of winding B is connected at a junction of the second high-side switch 524 and second low-side switch 530, and one end of winding C is connected at a junction of third high-side switch 526, and third low-side switch 532. The other end of windings A, B, and C are connected together in a “Y” shape (as shown), or delta shape (not shown). For current to flow into winding A and flow out from winding B, first high-side switch 522 is on and second low-side switch 530 is on, while keeping all other switches off. For current to flow into winding A and flow out from winding C, first high-side switch 522 is on and third low-side switch 532 is on, while keeping all other switches off. For current to flow into winding C and flow out from winding A, third high-side switch 526 is on and first low-side switch 528 is on, while keeping all other switches off. For current to flow into winding C and flow out from winding B, third high-side switch 526 is on and second low-side switches 530 is on, while keeping all other switches off. For current to flow into winding B and flow out from winding C, second high-side switch 524 is on and third low-side switch 532 is on, while keeping all other switches off. For current to flow into winding B and flow out from winding A, second high-side switch 524 is on and first low-side switch 528 is on, while keeping all other switches off. First ASIC 408 has a first high-to-low deadtime, and a first low-to-high deadtime. Similarly, second ASIC 412 has a second high-to-low deadtime, and a second low-to-high deadtime, and third ASIC 414 has a third high-to-low deadtime, and a third low-to-high deadtime. All six deadtimes may be programmable or non-programmable. Additionally, all six deadtimes may have similar dead time duration or different dead time durations. Generally, a deadtime state is a transient state where the ASIC transitions from a high-side on state to a low-side on state or vice versa.

While the embodiments have been described as having exemplary designs, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. A circuit, comprising:
a first high-side switch and a second high-side switch each receiving a source voltage;
a first low-side switch and a second low-side switch;
a first application specific integrated circuit (ASIC) connected to the first high-side switch and the first low-side switch; and
a second ASIC connected to the second high-side switch and the second low-side switch;
wherein the switches are connected to form an H-bridge circuit to generate a drive current; and
wherein the first and second ASICs control the switches in a synchronized manner to cause current to flow through a load in one of a first direction and a second direction.

2. The circuit in claim 1, wherein each of the switches is metal-oxide-semiconductor (MOS).

3. The circuit of claim 1, wherein at least one ASIC includes a control logic block configured to provide a programmable high-to-low deadtime, or a programmable low-to-high deadtime.

4. The circuit of claim 1, wherein the first ASIC has a first synchronization signal output and a first enable signal input, the second ASIC has a second synchronization signal output and a second enable signal input, the first synchronization signal output is connected to the second enable signal input and the second synchronization signal output is connected to the first enable signal input to synchronize operation of the first ASIC and the second ASIC.

5. The circuit of claim 1, wherein at least one ASIC includes at least one high-side diagnostic sensor connected in parallel across one of the high-side switches of the H-bridge, each high-side diagnostic sensor being configured to diagnose a fault in the corresponding one of the high-side switches of the H-bridge.

6. The circuit of claim 1, wherein at least one ASIC includes a low-side diagnostic sensor configured to sense a fault across the low-side switch of the H-bridge.

7. The circuit of claim 1, further including a sensor connected between ground and a junction of the first low-side switch and the second low-side switch, the sensor being configured to sense a current of the H-bridge.

8. A method, comprising:
generating a plurality of control signals; and
providing a first synchronization signal from a first application-specific integrated circuit (ASIC) to a second ASIC and a second synchronization signal from the second ASIC to the first ASIC for synchronizing the first ASIC with the second ASIC;
wherein the first ASIC and the second ASIC provide load drive signals to an H-bridge in response to the plurality of control signals and the synchronization signals so that one high-side of the H-bridge and one low-side of the H-bridge operates to drive a load.

9. The method in claim 8, further comprising:
operating the first ASIC in response to a low signal at a first enable signal input such that a first idle event occurs in which the first ASIC is idle;
operating the first ASIC in response to a high signal at the first enable signal input and a low signal at a first pulse width modulator input to cause a first low-side-on event in which the first ASIC generates a low signal at a first high-side gate drive (GH), and a high signal at a first low-side gate drive (GL);
operating the first ASIC in response to a high signal at the first enable signal input and a high signal at the first pulse width modulator input to cause a first high-side-on event in which the first ASIC generates a high signal at the GH and a low signal at the GL;
transitioning from the low-side-on event in response to a high signal at the first enable signal input and a high signal at the first pulse width modulator input to cause a first low-to-high deadtime event in which the first ASIC is off;
transitioning from a high-side-on event in response to a high signal at the first enable signal input and a low signal at the first pulse width modulator input to cause a first high-to-low deadtime event in which the first ASIC is off; and
operating the first ASIC in response to a high signal at a second synchronization signal to cause a first fault event in which the first ASIC is turned off.

10. The method in claim 8, further comprising:
operating the second ASIC in response to a low signal at a second enable signal input such that a second idle event occurs in which the second ASIC is idle;
operating the second ASIC in response to a high signal at a second enable signal input and a low signal at a second pulse width modulator input to cause a low-side-on event in which the second ASIC generates a low signal at a second GH, and a high signal at a second GL;
operating the second ASIC in response to a high signal at the second enable signal input and a high signal at the second pulse width modulator input to cause a high-side-on event in which the second ASIC generates a high signal at the GH and a low signal at the GL;
transitioning from the low-side-on event in response to a high signal at the second enable signal input and a high signal at the second pulse width modulator input to cause a second low-to-high deadtime event in which the second ASIC is off;
transitioning from the high-side-on event in response to a high signal at the second enable signal input and a low signal at the second pulse width modulator input to cause a second high-to-low deadtime event in which the second ASIC is off; and
operating the second ASIC in response to a high signal at a first synchronization signal to cause a second fault event in which the second ASIC is turned off

11. The method of claim 8, further comprising producing a fault signal in response to a diagnostic signal at one of a high-side switch, a low-side switch, or a current sensor.

12. A system, comprising:
a host logic module; and
a programmable load driver module coupled to the host logic module and configured to drive a load, wherein the programmable load driver module comprises an H-bridge circuit and a plurality of application-specific integrated circuits (ASICs);
wherein the H-bridge circuit is coupled to the plurality of ASICs and comprises two switches on a high-side of the H-bridge and two switches on a low-side of the H-bridge; and
wherein each of the plurality of ASICs has an output, the output from the first ASIC being provided as an input signal to the second ASIC and the output from the second ASIC being provided as an input signal to the first ASIC.

13. The system of claim 12, wherein at least one of the plurality of ASICs further comprises a programmable control logic block configured to provide load drive signals to the H-bridge.

14. A circuit, comprising:
a first high-side switch, a second high-side switch and a third high-side switch each receiving a source voltage;
a first low-side switch, a second low-side switch, and a third low-side switch;
a first application-specific integrated circuit (ASIC) connected to at least one of the first high-side switch, the second high-side switch and the third high-side switch, and at least one of the first low-side switch, the second low-side switch and the third low-side switch; and
a second ASIC connected to at least one of the first high-side switch, the second high-side switch and the third high-side switch, and at least one of the first low-side switch, the second low-side switch, and the third low-side switch;
wherein the ASICs control synchronized operation of the switches which are connected to form a three-phase circuit to generate a drive current.

15. The circuit of claim 14 further comprising a third ASIC, wherein the first ASIC is connected to the first high-side switch and the first low-side switch, the second ASIC is connected to the second high-side switch and the second low-side switch, and the third ASIC is connected to the third high-side switch and the third low-side switch.

16. The circuit of claim 15, wherein each of the switches is metal-oxide-semiconductor (MOS).

17. The circuit of claim 15, wherein at least one ASIC includes a control logic block configured to provide a programmable high-to-low deadtime, or a programmable low-to-high deadtime.

18. The circuit of claim 15, wherein the first ASIC has a first synchronization signal output and a first enable signal input, the second ASIC has a second synchronization signal output and a second enable signal input, and the third ASIC has a third synchronization signal output and a third enable signal input, wherein the first synchronization signal output is connected to the second enable signal input and to the third enable signal input, the second synchronization signal output is connected to the first enable signal input and the third enable signal input, and the third synchronization signal output is connected to the first enable signal input and the second enable signal input to synchronize the first ASIC, the second ASIC, and the third ASIC.

19. The circuit of claim 15, wherein at least one ASIC includes at least one high-side diagnostic sensor connected in parallel across one of the high-side switches of the three-phase circuit, wherein each high-side diagnostic sensor is configured to diagnose a fault in the corresponding one of the high-side switches of the three-phase circuit.

20. The circuit of claim 15, wherein at least one ASIC includes a low-side diagnostic sensor configured to sense a fault across a low-side switch of the three-phase circuit.

21. The circuit of claim 15, wherein each one of the high-side switches is connected to one of the corresponding low-side switches to form a bridge, each bridge including a sensor configured to sense a current in the three-phase circuit.

22. A system, comprising:
a host logic module; and
a programmable three-phase load driver module coupled to the host logic module and configured to drive a load, wherein the programmable three-phase load driver module comprises a three-phase power circuit and a plurality of application-specific integrated circuits (ASICs);
wherein the three-phase power circuit is coupled to the plurality of ASICs and comprises three MOS switches on a high-side of the three-phase power circuit and three MOS switches on a low-side of the three-phase power circuit; and
wherein each of the plurality of ASICs has an output, the output from the first ASIC being provided as an input signal to the second ASIC and the third ASIC, the output from the second ASIC being provided as an input signal to the first ASIC and the third ASIC, and the output from the third ASIC being provided as an input signal to the first ASIC and the second ASIC.

23. The system of claim 22, wherein at least one of the plurality of ASICs includes a control logic block configured to provide load drive signals to the three-phase power circuit.

24. A method, comprising:
generating a plurality of control signals; and
providing a first synchronization signal from a first application-specific integrated circuit (ASIC) to a second ASIC and a third ASIC, a second synchronization signal from the second ASIC to the first ASIC and the third ASIC, and a third synchronization signal from the third ASIC to the first ASIC and the second ASIC for synchronizing the first ASIC, the second ASIC, and the third ASIC;
wherein the first ASIC, the second ASIC, and the third ASIC provide load drive signals to a three-phase circuit in response to the plurality of control signals and the synchronization signals so that one high-side of the three-phase circuit and one low-side of the three-phase circuit operates to drive a load.

25. The method in claim 24, further comprising:
operating the first ASIC in response to a low signal at a first enable signal input such that a first idle event occurs in which the first ASIC is idle;
operating the first ASIC in response to a high signal at the first enable signal input and a low signal at a first pulse width modulator input to cause a first low-side-on event in which the first ASIC generates a low signal at a first high-side gate drive (GH), and a high signal at a first low-side gate drive (GL);
operating the first ASIC in response to a high signal at the first enable signal input and a high signal at the first pulse width modulator input to cause a first high-side-on event in which the first ASIC generates a high signal at the GH and a low signal at the second GL;
transitioning from the low-side-on event in response to a high signal at the first enable signal input and a high signal at the first pulse width modulator input to cause a first low-to-high deadtime event in which the first ASIC is off;
transitioning from a high-side-on event in response to a low signal at the first enable signal input and a high signal at the first pulse width modulator input to cause a first high-to-low deadtime event in which the first ASIC is off;
operating the first ASIC in response to a high signal at the second synchronization signal to cause a first fault event in which the first ASIC is turned off; and
operating the first ASIC in response to a high signal at the third synchronization signal to cause a first fault event in which the first ASIC is turned off.

26. The method in claim 24, further comprising:
operating the second ASIC in response to a low signal at a second enable signal input such that a second idle event occurs in which the second ASIC is idle;
operating the second ASIC in response to a high signal at a second enable signal input and a low signal at a second pulse width modulator input to cause a low-side-on event in which the second ASIC generates a low signal at a second GH, and a high signal at a second GL;
operating the second ASIC in response to a high signal at the second enable signal input and a high signal at the second pulse width modulator input to cause a high-side-on event in which the second ASIC generates a high signal at the GH and a low signal at the second GL;
transitioning from the low-side-on event in response to a high signal at the second enable signal input and a high signal at the second pulse width modulator input to cause a second low-to-high deadtime event in which the second ASIC is off;
transitioning from the high-side-on event in response to a low signal at the second enable signal input and a high signal at the second pulse width modulator input to cause a second high-to-low deadtime event in which the second ASIC is off;
operating the second ASIC in response to a high signal at the first synchronization signal to cause a second fault event in which the second ASIC is turned off; and
operating the second ASIC in response to a high signal at the third synchronization signal to cause the second fault event in which the second ASIC is turned off.

27. The method in claim 24, further comprising:
operating the third ASIC in response to a low signal at a third enable signal input such that a third idle event occurs in which the third ASIC is idle;
operating the third ASIC in response to a high signal at a third enable signal input and a low signal at a third pulse width modulator input to cause a low-side-on event in which the third ASIC generates a low signal at a third GH, and a high signal at a third GL;
operating the third ASIC in response to a high signal at the third enable signal input and a high signal at the third pulse width modulator input to cause a high-side-on event in which the third ASIC generates a high signal at the GH and a low signal at the third GL;
transitioning from the low-side-on event in response to a high signal at the third enable signal input and a high signal at the third pulse width modulator input to cause a third low-to-high deadtime event in which the third ASIC is off;
transitioning from the high-side-on event in response to a low signal at the third enable signal input and a high signal at the third pulse width modulator input to cause a third high-to-low deadtime event in which the third ASIC is off;
operating the third ASIC in response to a high signal at the first synchronization signal to cause a third fault event in which the third ASIC is turned off; and
operating the third ASIC in response to a high signal at the second synchronization signal to cause the third fault event in which the third ASIC is turned off.

28. The method of claim 24, further comprising producing a fault signal in response to a diagnostic signal at one of a high-side switch, a low-side switch, or a current sensor.
